(19) United States
(12) Patent Application Publication
(10) Pub. No.: US 2021/0360201 A1
(43) Pub. Date: Nov. 18, 2021

(54) METHODS, SYSTEMS, APPARATUSES, AND DEVICES FOR FACILITATING MONITORING OF AN ENVIRONMENT

(71) Applicant: MatchX GmbH, Berlin (DE)

(72) Inventor: Xin Hu, Berlin (DE)

(21) Appl. No.: 17/302,920

(22) Filed: May 14, 2021

Related U.S. Application Data
(60) Provisional application No. 63/024,716, filed on May 14, 2020.

(51) Int. Cl. H04N 7/18; G06K 9/00; G06T 7/70; H04N 5/232; H04N 5/247; G08B 13/196; H02S 20/30; G03B 17/08; F03D 9/00

(52) U.S. Cl. CPC H04N 7/181; G06T 2207/10048; G06T 7/70; H04N 5/23241; H04N 5/247; H04N 5/23216; H04N 5/23218; H04N 7/188; G08B 13/19602; G08B 13/1966; H02S 20/30; G03B 17/08; F03D 9/00; G06T 2207/30232; G06K 9/00771

(57) ABSTRACT

Disclosed herein is a system for facilitating monitoring an environment. Accordingly, the system comprises a camera, an artificial intelligence (AI) processing unit, a radio unit, and at least one alternative energy capturing device. Further, a camera device is configured for capturing video of an environment. Further, an AI processing unit is responsible to analyze captured videos, detect whether certain relevant events occurred, make a decision, then generate relevant alert. Further, the radio unit is capable to send the generated alert to different devices. Further, the alternative energy capture device can use solar or other energy source to keep the entire system running.

### FIELD OF THE INVENTION

Generally, the present disclosure relates to the field of data processing. More specifically, the present disclosure relates to methods, systems, apparatuses, and devices for facilitating monitoring of an environment.

### BACKGROUND OF THE INVENTION

The current surveillance system embodiment includes a recording camera, connected to a back-end controller unit with a possibility of transmission using any wireless network protocols like SPI/UART/I2C. In the case of wired surveillance cameras, the installation and maintenance of the system is expensive and also not feasible in case of certain settings like large parking lots, multi-level shopping complexes, and open farms or orchards with limited access to electric power. Since these areas are in an open setting, they receive a continuous supply of solar power, which the current surveillance camera control method fails to harness due to their use of electricity through cabled networks, as their power supply. The main advantage of networked surveillance lies in the fact that since the mounting is mobile and the front-end camera is very easily controlled using remote sensing or other interfacings to regulate the video capture and stream, which is then sent to a back-end NVR (Network Video Recorder).

Some of the drawbacks encountered in the current use-cases which find applications in the modern surveillance systems are difficult to avoid.

The setup and installation of these systems require multiple cameras, memory storage units, CCTV cameras, cables, Ethernet connections, routers, switches, and a monitoring unit. These systems require continuous physical intervention by a human controlling and monitoring using a control PC connected to all the cameras in the surveillance area. This, owing to the lower attention span of humans and difficulty of round the clock physical intervention, gives rise to chances of ignoring details and failing to recognize patterns during emergency situations. Detecting these unusual activities require high mental and physical efficiency for a long period of time.

These modern systems are usually powered by electric supply from the households or corporate buildings, which make it really difficult to install the same setting in open spaces far from any household or availability, like big farms and orchards outside the city spaces. With huge standby times, these cameras are also prone to use a lot of power having a large portion of their operation as idle time. So eventually this reduces the performance life of these systems.

These cameras and video systems record and operate on a large amount of data and most of the places under surveillance are open public places. This always exposes these videos to a third party and causes privacy concerns, especially if the data is being continuously transmitted to an external cloud or server or commercial APIs. Sometimes these servers or clouds are privately owned by large organizations, in geographical locations like the European Union this violates GDPR restrictions on various grounds. With this massive amount of data being collected, sometimes these video streams are not being used to improve analytics or to their full potential.

These surveillance systems are installed in open areas, exposing them to rainwaters and strong winds. In cases of wired connections and cables, these waters can severely damage the system. These are some of the major challenges faced by the modern surveillance and CCTV systems being used.

Therefore, there is a need for improved methods, systems, apparatuses, and devices for facilitating monitoring of an environment that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a system for facilitating monitoring of an environment, in accordance with some embodiments. Accordingly, the system may include at least one camera, an artificial intelligence (AI) processing unit, a radio unit, and at least one alternative energy capturing device. Further, the at least one camera may be configured for capturing at least one image of the environment. Further, the artificial intelligence (AI) processing unit may be communicatively coupled with the at least one camera. Further, the AI processing unit may be configured for analyzing the at least one image using at least one machine learning model. Further, the at least one machine learning model may be trained in at least one of object detection and object recognition. Further, the AI processing unit may be configured for detecting at least one of an identity and a location of at least one object present in the environment based on the analyzing. Further, the AI processing unit may be configured for determining a situation occurring in the environment based on the analyzing and the detecting. Further, the AI processing unit may be configured for generating an alert for the situation based on the determining. Further, the radio unit may be communicatively coupled with the AI processing unit. Further, the radio unit may be configured for transmitting the alert to at least one device. Further, the at least one alternative energy capturing device may be electrically coupled with the at least one camera, the AI processing unit, and the radio unit. Further, the at least one alternative energy capturing device may be configured for harvesting alternative energy from at least one alternative energy source. Further, the at least one alternative energy capturing device may be configured for powering the at least one camera, the AI processing unit, and the radio unit based on the harvesting.

Further disclosed herein is a system for facilitating monitoring of an environment, in accordance with some embodiments. Accordingly, the system may include at least one camera, an artificial intelligence (AI) processing unit, a radio unit, at least one alternative energy capturing device, and at least one passive sensor. Further, the at least one camera may be configured for capturing at least one image of the environment. Further, the artificial intelligence (AI) processing unit may be communicatively coupled with the at least one camera. Further, the AI processing unit may be configured for analyzing the at least one image using at least one machine learning model. Further, the at least one machine learning model may be trained in at least one of object detection and object recognition. Further, the AI processing unit may be configured for detecting at least one of an identity and a location of at least one object present in the environment based on the analyzing. Further, the AI processing unit may be configured for determining a situation occurring in the environment based on the analyzing and the detecting. Further, the AI processing unit may be configured for generating an alert for the situation based on the determining. Further, the radio unit may be communicatively coupled with the AI processing unit. Further, the radio unit may be configured for transmitting the alert to at least one device. Further, the at least one alternative energy capturing device may be electrically coupled with the at least one camera, the AI processing unit, and the radio unit. Further, the at least one alternative energy capturing device may be configured for harvesting alternative energy from at least one alternative energy source. Further, the at least one alternative energy capturing device may be configured for powering the at least one camera, the AI processing unit, and the radio unit based on the harvesting. Further, the at least one passive sensor may be communicatively coupled with the at least one camera. Further, the at least one passive sensor may be configured for generating at least one signal based on passively sensing a presence of the at least one object in the environment. Further, the at least one camera may be configured to be activated for the capturing of the at least one image of the environment based on the at least one signal.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating monitoring of an environment, in accordance with some embodiments.

FIG. 3 is a block diagram of the system for facilitating the monitoring of the environment, in accordance with some embodiments.

FIG. 4 is a block diagram of the system for facilitating the monitoring of the environment, in accordance with sonic embodiments.

FIG. 5 is a block diagram of a system for facilitating monitoring of an environment, in accordance with some embodiments.

FIG. 6 is a block diagram of a surveillance system for facilitating monitoring of an environment, in accordance with some embodiments.

FIG. 7 is a block diagram of the AI processing board of the surveillance system, in accordance with some embodiments.

FIG. 8 illustrates functioning of the surveillance system on a time-scale basis from start to end, in accordance with some embodiments.

FIG. 9 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating monitoring of an environment, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a (GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more, and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods, systems, apparatuses, and devices for facilitating monitoring of an environment.

Further, the present disclosure describes an apparatus and a method for a solar powered AI wireless camera.

Further, the present disclosure describes five modules for facilitating the monitoring of the environment. Further, the five modules are enclosed in a water-proof enclosure and powered from a solar panel to selectively record and analyze video screenings from large and small-scale security settings, a process using AI-edge models without strict requirements of 4G/5G communication protocols between the cloud or server and the processing board, by means of radio communication. The hardware modules housed in the enclosure are—a Radio Unit, a Micro-controller Unit, a battery charging unit, a Machine Learning Unit, a Digital or Analogue interface unit depending upon the requirement and setting of the camera unit.

Further, the present disclosure describes an embodiment of a surveillance system that may include a microcontroller unit. Further, the microcontroller unit is used to interface all the different parts in the camera system and act as a controlling unit in between the battery powered by the photovoltaic panel, the AI processing board, MCU, camera module, and the transmission unit. It also enables the design to adapt and be programmed for additional uses. Any program designs can be flashed into the microcontroller depending upon the functionality desired from the video streams. Further, the embodiment of the surveillance system may include PV panels or photo-voltaic panels. Further, the PV panels are widely used as a power supply of embedded and IoT application devices in open spaces, these days to convert solar power into electricity and conveniently store it into a battery. The main advantage of this application lies in the fact it can be installed in areas without electricity and since most of the surveillance areas include open parking lots, garages, farms, orchards, community parks that receive sufficient sunlight throughout the days this option is suitable for powering the front-end camera. The solar module is mounted together with the surveillance camera system, which can be together controlled easily as a single gear clamped setting. Further, a Machine learning unit is also included in the embodiment to handle pre-trained neural network models to suitably control the video streams from the camera unit and include machine learning functionalities in the unit. These Machine Learning units are designed in a way to reduce the power consumption of the unit and particularly suitable for edge connectivity over any low bandwidth network protocols (like LoRAWAN and LIE Cat-M or NB-IoT). These are particularly suited for AI frameworks and models for applications like object detection, image classification, and motion detection according to the design of the video stream requirement. Further, the embodiment of the surveillance system may include a PIR (Passive Infrared Sensor). Further, the PIR is used as a digital device interfacing unit with the main master Micro-controller. These find similar applications in security alarm systems and other embedded applications which are based on detection and counting of objects, rather than identifying those objects. This works on the principle of motion detection and monitoring of outdoor activities by detecting infrared radiations or thermal energy emissions emitted or reflected from different reflective surfaces. These are usually interfaced using a suitable communication protocol with other I/O devices to the Microcontroller being used.

Further, the main application of the embodiment of the surveillance system is aimed at large areas which are at the risk of public trespassing or require manual intervention by a physical person. Such areas include shopping malls, parking lots, garages, villas, resorts, houses, factory outlets, community parks, farms, and orchards. Since it does not require a physical interference to control or record the video streams, the requirements for the back-end surveillance of this camera are minimal. Hence the setup can be done for any area easily and the communication allowance for the data streams even in absence of 4G/5G makes it a more viable option for areas with less connectivity. The patent is designed to work with all existing bandwidths of WIFI, Bluetooth, LoRAWAN, and LPWAN also, which makes it usable in areas not reachable by high quality wider bandwidth connections. The setting is designed to withstand normal natural calamities and regular water showers, owing to its rated water-proof housing and wireless embodiment. It can be used for open places receiving high amounts of rain, difficult to manually patrol or set up a cabled connection. Highly inflammable like Oil Refineries areas can also be included for surveillance, such as the communication between surveillance systems and the notification or alarming devices are very efficient. This is majorly due to the reason an AI algorithm recognizes the early signs of fire and reduces the risks of physical monitoring. A PIR sensor interfaced ensures thermal radiation reflected to be detected and thereby, clear night time vision also.

Further, the discussed embodiment is a plug and play solution for surveillance cameras with no or minimal setup. It involves the wireless transmission of data and video stream over a radio antenna using any communication protocol and bandwidth (WiFi, 3G, 4G, NB-IoT, or LoRAWAN/LPWAN). Further, the embodiment of the surveillance system is based on the principle of selective Video stream capture and not continuous recording reducing the idle stand-by time of the camera when there is no activity or point of interest in the field of view which saves a lot of battery time and in turn, charges it using the photovoltaic capture. The inactive hours of surveillance are avoided in the system which increases the battery life to a great extent. In case of trespassing or vehicle identification during accidents, the AI processing unit containing the pre-trained Machine Learning models operates on very low power. Hence it reduces the battery consumption from the power unit and in turn, increases the battery life considerably. The disclosure does not need a physical monitoring unit or a control PC as the AI Processing unit does the part of image classification, object detection, and monitoring depending on the inputs obtained from the PIR sensor interfaced to it. Further, the embodiment of the surveillance system may include a device that is being interfaced with a connected radio unit like NB-IoT radio device, related Bluetooth or wireless devices, and mobile phones of customers. This enables the camera to communicate with the user and notify the user in the form of a SMS, push notification, or mobile app notification. Since the camera is operated by the local AI processing unit, in case of emergencies or detection of adversities in the field of vision like an occurrence of fire or face detection of a trespasser, a SMS can be sent to the user's mobile phone connected to the surveillance system or a fire alarm system can ring to make the user aware of the fire. Since the video is not needed to be sent to a cloud or a server and is based on the principle of Edge-communication on the device end, it is totally compliant with the European GDPR policies of transmission to an external device or network outside the European Union. Further, the surveillance system is powered by a solar photovoltaic panel, which can be a fixed unit separate from the camera or a flexible array of PV cells fixed atop the camera unit. The surveillance system has no external requirements of power supply apart from this which makes it easy to set up the system with minimum wired and cable connections. All the units of the surveillance system including the AI Processing unit, Camera, PIR sensor, Battery are housed inside a waterproof outdoor unit. This makes it able to withstand normal rain showers, hurricanes, and typhoons.

The present disclosure relates to the use of power from a solar powered photovoltaic cell being mounted on top of the camera unit, which enables free movement of both the panel and the camera unit, for maximum power capture according to the solar power received. The photovoltaic plates can be a flexible coating over the camera body. The camera body is held onto the panel by a mounting channel affixed to the standing seam of the metal body of the video camera. The photovoltaic plate can be a flexible array of FPCB substrate, attached above the camera or a fixed plate separate from the camera setup for a free 360-degree movement. Each array in the solar cell is a fused PN junction diode that gets activated on receiving solar energy and produces electricity in between the associated cathodes and anodes. These are then harnessed by the electric battery unit at a predetermined DC load and voltage, for later use by the other processing units. In the discussed setting, the battery unit houses the Panasonic 18650 lithium-ion battery sets. The Energy Storage Unit houses an Inverter connected to the battery, and a charge controller to prevent over-storage of energy.

Usually, a surveillance camera can be classified as a fixed or a rotary camera depending on its applications. The mentioned disclosure is a PTZ (Pan, Tilt, Zoom) has a range of motion called panning (free left to right movement) spanning the width of an area, vertical tilt which is upward or downward motion and zooming in and out into a field of view. The setting houses a lens, a camera, and a solar power supply from the photovoltaic panels which can be a flexible plate on the top of the camera covering it. The video streams generated need no monitoring and do not require a multi-screen viewer, a recording unit, a control PC, or continuous physical handling by a person. It can be however stored in on-the-device solid-state storage devices or cards installed inside the camera system, which can be later used for training neural network models for object detection, fire recognition, or any other such functionalities. The camera provides clear vision at night also, due to its infra-red vision capability and can withstand rainwater, hurricanes, and typhoons due to its waterproof housing.

A surveillance camera usually has different properties including panning an area, covering a particular curvature and zooming in and out of the span. In the above disclosure, all these functionalities are controlled by the pre-trained models fed to the Machine Learning unit. Hence the back end of the camera requires no manual intervention or physical monitoring by a person, which is suitable in case of emergency situations like accidents, fire prevention, and theft where continuous monitoring or recording of the stream is not required. The machine learning model can be trained as Neural Networks for object recognition, which can be trained to zoom in and capture the number plates in case of cars or faces during theft or trespassing.

This is particularly handled by the AI Processing unit which contains any low power consuming Machine Learning unit (Google's Edge TPU, NVIDIA Jetson, Raspberry Pi 4) suitable for that particular functionality. A PIR sensor is also interfaced with this microcontroller which is based on the principle of IR enabled thermal imaging. It is mainly used to detect people's intrusion, fire in the vicinity by capturing reflected thermal radiation or Infrared waves from these bodies. With modern image classifying algorithms surpassing human level accuracy, this is the perfect example to automate a mundane manual task to an AI processing unit. Heavily engineered neural network models are trained with video streams to recognize intrusions, emergency, and other threat patterns through Object Detection along with Segmentation Unlike other object detection algorithms, the exact location of objects in the video stream is of importance. Some of the prevailing models which are efficient for this are the Faster RCNN with ResNet 50 (Deep Residual Learning), YOLO (You Only Look Once—real time object detection), and other Single Shot Detector (SSD networks).

The required video streams are continuously being sent to a dedicated networked server through a transceiver radio antenna unit which enables data transmission by any communication protocol or bandwidth (WiFi, LoRaWAN, LTE). This can enable the surveillance system to further send an SMS to the user's mobile phone as an alert message to the user. The communication is enabled by the radio unit interfaced with the AI processing unit. A transceiver antenna is attached to the system which broadcasts video streams using two-way radio communication between the unit and any wireless networks, any IoT devices, a Bluetooth enabled device, or cellphones of users. The advantage of this mode of data transmission is it is not restricted to any particular communication bandwidth. So, the system is able to work over LoRAWAN, LPWAN (current and upcoming bandwidths), or even in 3G/4G and 5G connections. In the case of multiple camera systems, the communication protocol is encoded with specific radio frequencies of alternating currents, specific to the identification tags embedded in the detection antenna of the respective surveillance system.

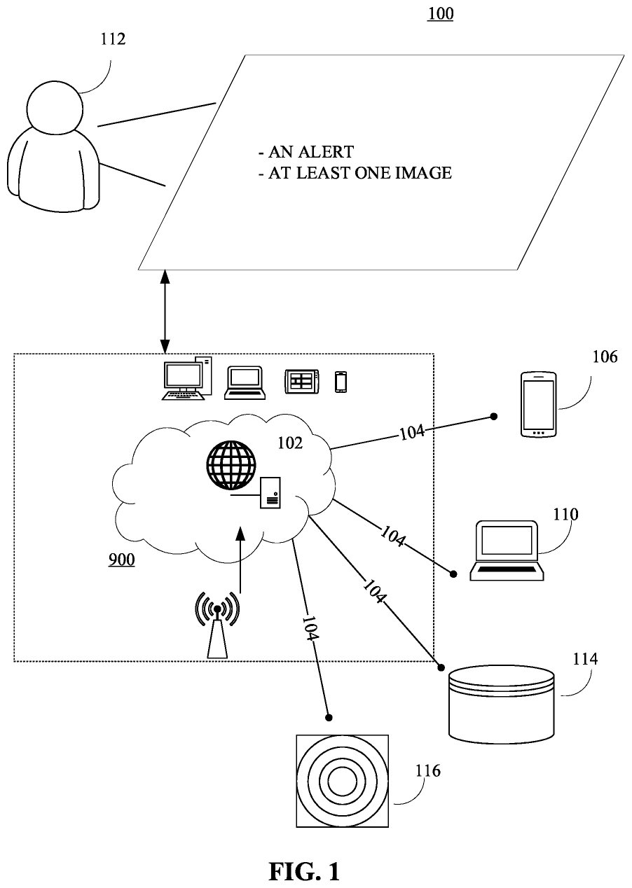

FIG. 1 is an illustration of an online platform 100 consistent with various embodiments of the present disclosure. By way of non-limiting example, the online platform 100 to facilitate monitoring of an environment may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 900.

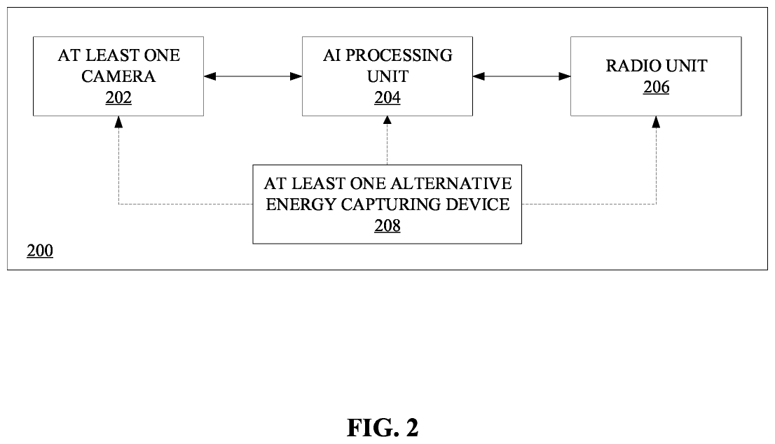

FIG. 2 is a block diagram of a system 200 for facilitating monitoring of an environment, in accordance with some embodiments. Further, the system 200 may include at least one camera 202, an artificial intelligence (AI) processing unit 204, a radio unit 206, and at least one alternative energy capturing device 208.

Further, the at least one camera 202 may be configured for capturing at least one image of the environment. Further, the environment may be an indoor environment, an outdoor environment, etc.

Further, the artificial intelligence (AI) processing unit 204 may be communicatively coupled with the at least one camera 202. Further, the AI processing unit 204 may be configured for analyzing the at least one image using at least one machine learning model. Further, the at least one machine learning model may be trained in at least one of object detection and object recognition. Further, the AI processing unit 204 may be configured for detecting at least one of an identity and a location of at least one object present in the environment based on the analyzing. Further, the AI processing unit 204 may be configured for determining a situation occurring in the environment based on the analyzing and the detecting. Further, the situation may include an emergency situation. Further, the situation may include theft, explosion, fire, ransacking, looting, rioting, crowding, etc. Further, the AI processing unit 204 may be configured for generating an alert for the situation based on the determining.

Further, the radio unit 206 may be communicatively coupled with the AI processing unit 204. Further, the radio unit 206 may be configured for transmitting the alert to at least one device.

Further, the at least one alternative energy capturing device 208 may be electrically coupled with the at least one camera 202, the AI processing unit 204, and the radio unit 206. Further, the at least one alternative energy capturing device 208 may be configured for harvesting alternative energy from at least one alternative energy source. Further, the at least one alternative energy capturing device 208 may be configured for powering the at least one camera 202, the AI processing unit 204, and the radio unit 206 based on the harvesting.

Further, in some embodiments, the at least one alternative energy capturing device 208 may include a photovoltaic panel comprised of one or more photovoltaic cells. Further, the one or more photovoltaic cells may be configured for harvesting solar energy from sunlight. Further, the powering of the at least one camera 202, the AI processing unit 204, and the radio unit 206 may be based on the harvesting of the solar energy.

Further, in an embodiment, the photovoltaic panel may be configured to be mounted on the at least one camera 202 using at least one mounting mechanism. Further, the at least one mounting mechanism may be configured to allow for independent movement of the photovoltaic panel and the at least one camera 202. Further, the one or more photovoltaic cells receive the sunlight based on mounting of the photovoltaic panel. Further, the harvesting of the sunlight may be based on receiving of the sunlight.

Further, in an embodiment, the one or more photovoltaic cells may be comprised in a camera body of the at least one camera 202 forming the photovoltaic panel on the camera body. Further, the camera body may be exposed to the sunlight. Further, the one or more photovoltaic cells receive the sunlight based on exposing of the photovoltaic panel. Further, the harvesting of the sunlight may be based on receiving of the sunlight.

Further, in some embodiments, the at least one camera 202 may include at least one of a visible light camera and an infrared light camera. Further, the visible light camera may be configured for capturing at least one visible light image of the environment and the infrared light camera may be configured for capturing at least one infrared light image of the environment. Further, the at least one image may include at least one of the at least one visible light image and the at least one infrared light image.

In further embodiments, a weatherproof enclosure may be configured for housing at least one of the at least one camera 202, the AI processing unit 204, and the radio unit 206. Further, the weatherproof enclosure may be configured for shielding at least one of the at least one camera 202, the AI processing unit 204, and the radio unit 206 from at least one weather condition of the environment based on the housing. Further, the at least one weather condition may include rain, hail, storm, hurricane, insolation, etc.

Further, in some embodiments, the at least one camera 202 may be configured for capturing at least one subsequent image based on the determining of the situation. Further, the AI processing unit 204 may be configured for analyzing the at least one subsequent image using at least one first machine learning model. Further, the at least one first machine learning model may be trained in at least one of object detection and object recognition associated with the situation. Further, the AI processing unit 204 may be configured for identifying at least one object of interest associated with the situation based on the analyzing of the at least one subsequent image. Further, the at least one object of interest provides insight into the situation. Further, the at least one object of interest may be used for determining an accountability for the situation. Further, the AI processing unit 204 may be configured for generating at least one command for the at least one camera 202 based on the identifying of the at least one object of interest. Further, the at least one camera 202 may be configured for configuring at least one camera parameter of the at least one camera 202 for capturing at least one identifiable image of the at least one object of interest based on the at least one command. Further, the at least one identifiable image may be used for humanly identify the at least one object of interest. Further, the at least one camera parameter may include a zoom, a tilt, a pan, a focus, etc. Further, the radio unit 206 may be configured for transmitting the at least one identifiable image to the at least one device.

Further, in some embodiments, the radio unit 206 may be configured for transmitting the at least one image to the at least one device. Further, the at least one device may be configured for presenting the at least one image to at least one user associated with the at least one device. Further, the at least one device may include a presentation device. Further, in an embodiment, the transmitting of the at least one image may include broadcasting the at least one image to the at least one device using at least one wireless communication network. Further, the at least one device may be configured to be connected to the at least one wireless communication network.

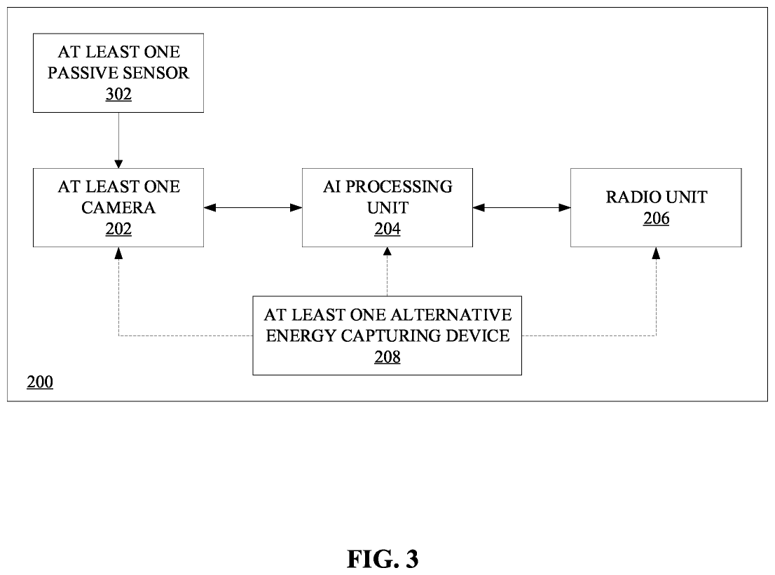

In further embodiments, at least one passive sensor 302, as shown in FIG. 3, may be communicatively coupled with the at least one camera 202. Further, the at least one passive sensor 302 may include a passive infrared sensor. Further, the at least one passive sensor 302 may be configured for generating at least one signal based on passively sensing a presence of the at least one object in the environment. Further, the at least one camera 202 may be configured to be activated for the capturing of the at least one image of the environment based on the at least one signal. Further, in an embodiment, the at least one passive sensor 302 may be configured for generating at least one first signal based on passively sensing a movement of the at least one object in the environment based on the passively sensing of the presence of the at least one object. Further, the at least one camera 202 may be configured to be activated for the capturing of the at least one image of the environment based on the at least one first signal.

Further, in some embodiments, the at least one device may include at least one alarm device. Further, the at least one alarm device may be configured for outputting an alarm signal based on the alert. Further, the alarm signal may include a sound signal, a light signal, a haptic signal, etc.

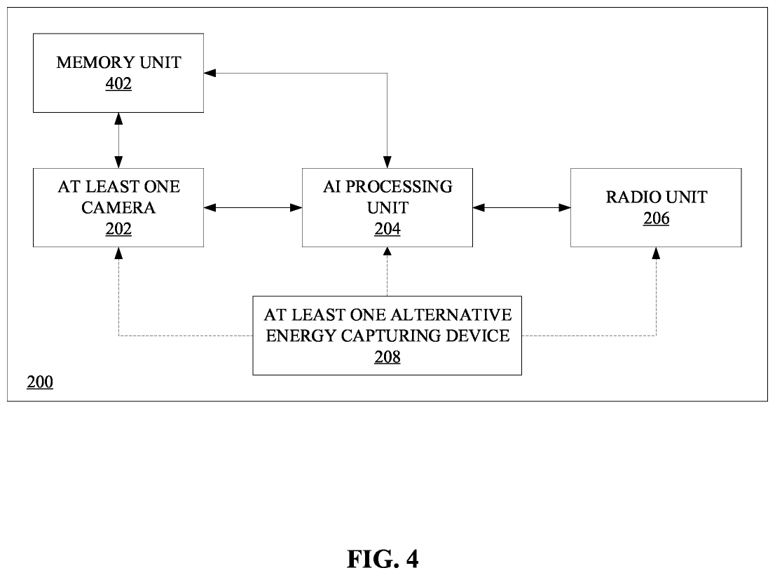

In further embodiments, a memory unit 402, as shown in FIG. 4, may be communicatively coupled with the at least one camera 202. Further, the memory unit 402 may be configured for storing the at least one image. Further, in an embodiment, the memory unit 402 may be communicatively coupled with the AI processing unit 204. Further, the memory unit 402 may be configured for retrieving at least one historical image of the environment. Further, the AI processing unit 204 may be configured for analyzing the at least one historical image of the environment using at least one second machine learning model. Further, the at least one second machine learning model may be trained in pattern detection of historical occurrences of the situations in the environment. Further, the AI processing unit 204 may be configured for determining a part of a day with a likelihood of the occurring of the situation based on the analyzing of the at least one historical image. Further, the AI processing unit 204 may be configured for generating at least one first command based on the determining of the part of the day. Further, the at least one camera 202 may be configured to be activated for the part of the day for the capturing of the at least one image based on the at least one first command. Further, in some embodiments, the at least one alternative energy capturing device 208 may include a wind turbine. Further, the wind turbine may be configured for harvesting wind energy from wind. Further, the powering of the at least one camera 202, the AI processing unit 204, and the radio unit 206 may be based on the harvesting of the wind energy.

FIG. 3 is a block diagram of the system 200 for facilitating the monitoring of the environment, in accordance with some embodiments.

FIG. 4 is a block diagram of the system 200 for facilitating the monitoring of the environment, in accordance with some embodiments.

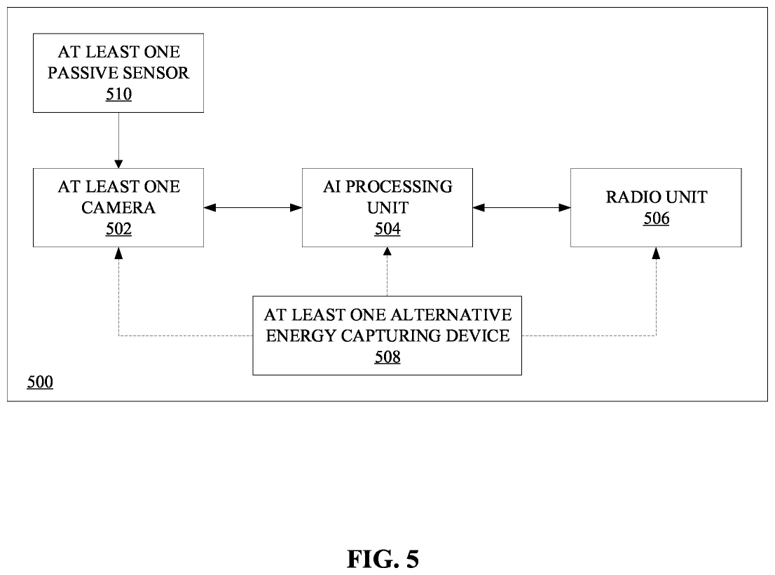

FIG. 5 is a block diagram of a system 500 for facilitating monitoring of an environment, in accordance with some embodiments. Further, the system 500 may include at least one camera 502, an artificial intelligence (AI) processing unit 504, a radio unit 506, at least one alternative energy capturing device 508, and at least one passive sensor 510.

Further, the at least one camera 502 may be configured for capturing at least one image of the environment.

Further, the artificial intelligence (AI) processing unit 504 may be communicatively coupled with the at least one camera 502. Further, the AI processing unit 504 may be configured for analyzing the at least one image using at least one machine learning model. Further, the at least one machine learning model may be trained in at least one of object detection and object recognition. Further, the AI processing unit 504 may be configured for detecting at least one of an identity and a location of at least one object present in the environment based on the analyzing. Further, the AI processing unit 504 may be configured for determining a situation occurring in the environment based on the analyzing and the detecting. Further, the AI processing unit 504 may be configured for generating an alert. for the situation based on the determining. Further, the radio unit 506 may be communicatively coupled with the AI processing unit 504. Further, the radio unit 506 may be configured for transmitting the alert to at least one device.

Further, the at least one alternative energy capturing device 508 may be electrically coupled with the at least one camera 502, the AI processing unit 504, and the radio unit 506. Further, the at least one alternative energy capturing device 508 may be configured for harvesting alternative energy from at least one alternative energy source. Further, the at least one alternative energy capturing device 508 may be configured for powering the at least one camera 502, the AI processing unit 504, and the radio unit 506 based on the harvesting.

Further, the at least one passive sensor 510 may be communicatively coupled with the at least one camera 502. Further, the at least one passive sensor 510 may be configured for generating at least one signal based on passively sensing a presence of the at least one object in the environment. Further, the at least one camera 502 may be configured to be activated for the capturing of the at least one image of the environment based on the at least one signal.

Further, in some embodiments, the photovoltaic panel may be configured to be mounted on the at least one camera 502 using at least one mounting mechanism. Further, the at least one mounting mechanism may be configured to allow for independent movement of the photovoltaic panel and the at least one camera 502. Further, the one or more photovoltaic cells receive the sunlight based on mounting of the photovoltaic panel. Further, the harvesting of the sunlight may be based on receiving of the sunlight.

Further, in sonic embodiments, the one or more photovoltaic cells may be comprised in a camera body of the at least one camera 502 forming the photovoltaic panel on the camera body. Further, the camera body may be exposed to the sunlight. Further, the one or more photovoltaic cells receive the sunlight based on exposing of the photovoltaic panel. Further, the harvesting of the sunlight may be based on receiving of the sunlight.

Further, in some embodiments, the at least one camera 502 may include at least one of a visible light camera and an infrared light camera. Further, the visible light camera may be configured for capturing at least one visible light image of the environment and the infrared light camera may be configured for capturing at least one infrared light image of the environment. Further, the at least one image may include at least one of the at least one visible light image and the at least one infrared light image.

In further embodiments, a weatherproof enclosure may be configured for housing at least one of the at least one camera 502, the AI processing unit 504, and the radio unit 506. Further, the weatherproof enclosure may be configured for shielding at least one of the at least one camera 502, the AI processing unit 504, and the radio unit 506 from at least one weather condition of the environment based on the housing.

Further, in some embodiments, the at least one passive sensor 510 may be configured for generating at least one first signal based on passively sensing a movement of the at least one object in the environment based on the passively sensing of the presence of the at least one object. Further, the at least one camera 502 may be configured to be activated for the capturing of the at least one image of the environment based on the at least one first signal of the at least one image of the environment based on the at least one signal.

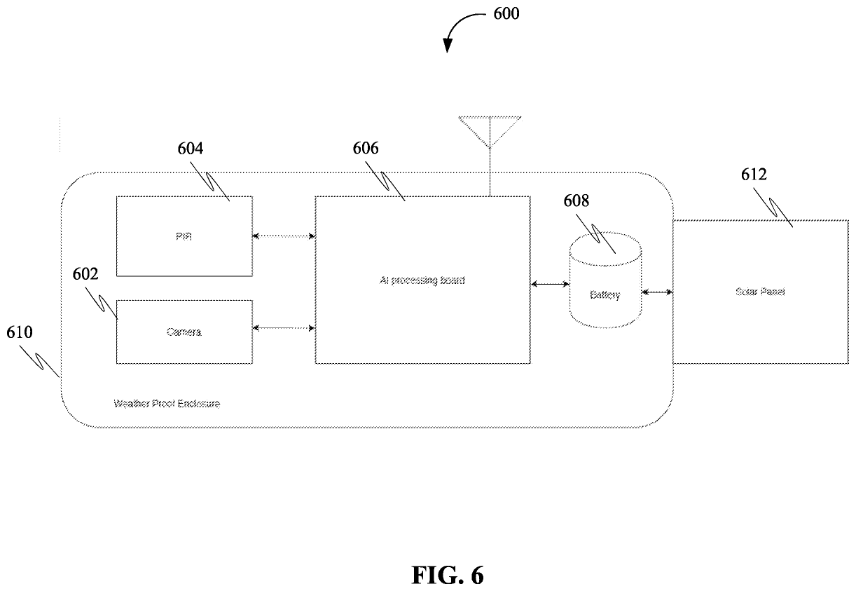

FIG. 6 is a block diagram of a surveillance system 600 for facilitating monitoring of an environment, in accordance with some embodiments. Further, the surveillance system 600 may include a weatherproof enclosure 610, a battery 608, a solar panel 612, an AI processing board 606, a PIR sensor 604, and a camera unit 602. Further, the weatherproof enclosure 610 houses the battery 608, the AI processing board 606, the PIR sensor 604, and the camera unit 602. Further, the battery 608 may be configured to store solar power harvested using the solar panel 612. Further, the camera unit 602 may be configured to record video data.

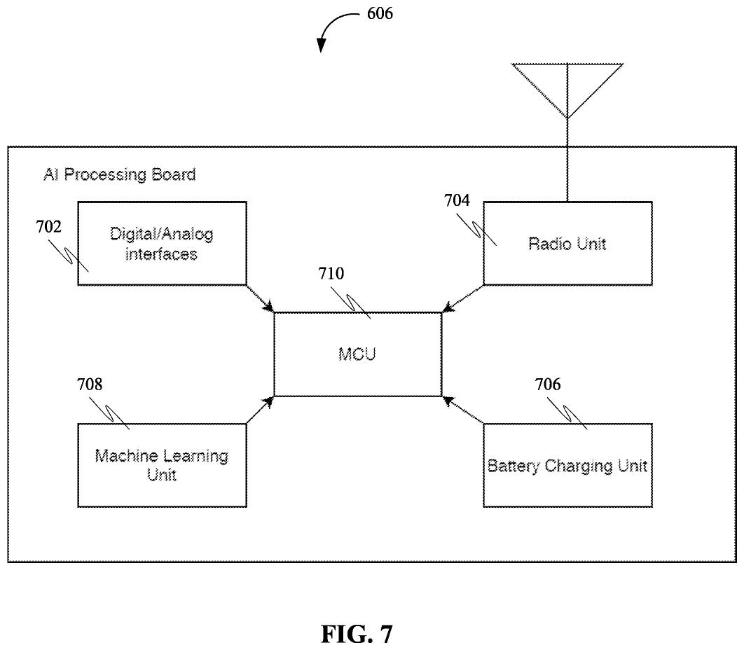

FIG. 7 is a block diagram of the AI processing board 606 of the surveillance system 600, in accordance with some embodiments. Further, the AI processing board 606 may include digital/analog interfaces 702, a radio unit 704, a battery charging unit 706, a machine learning unit 708, and a MCU (microcontroller unit) 710. Further, the radio unit 704 may be configured to communicate the video data out of the camera unit 602 and a PTZ camera. Further, the MCU 710 may be based on any common Edge TPU Developer Kit in the market namely NVIDIA Jetson Nano, Raspberry Pi4 Model, and Coral DevBoard. Further, the digital/analog interfaces 702 may be configured for interfacing with the PIR sensor 604.

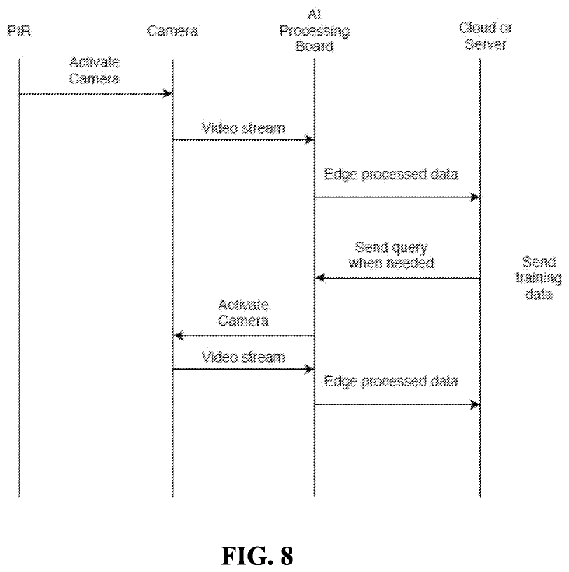

FIG. 8 illustrates functioning of the surveillance system 600 on a time-scale basis from start to end, in accordance with some embodiments. It starts with activating the front-end video camera for capture and recording by the PIR sensor using the principle of thermal activation. The camera sends the captured video stream to the AI Processing board to work on the required stream of data, using pre-trained models. In general cases, the stream of data may be fed to a Neural Network Model for Object Detection algorithm in certain cases or in emergency cases like fire alarms, the stream of data may be used to notify the customer of a possible occurrence of fire. Further, on any requests or queries generated while training the Machine Learning models, a cloud or server may be always reached out and the requested data sent back to the AI Processing board.

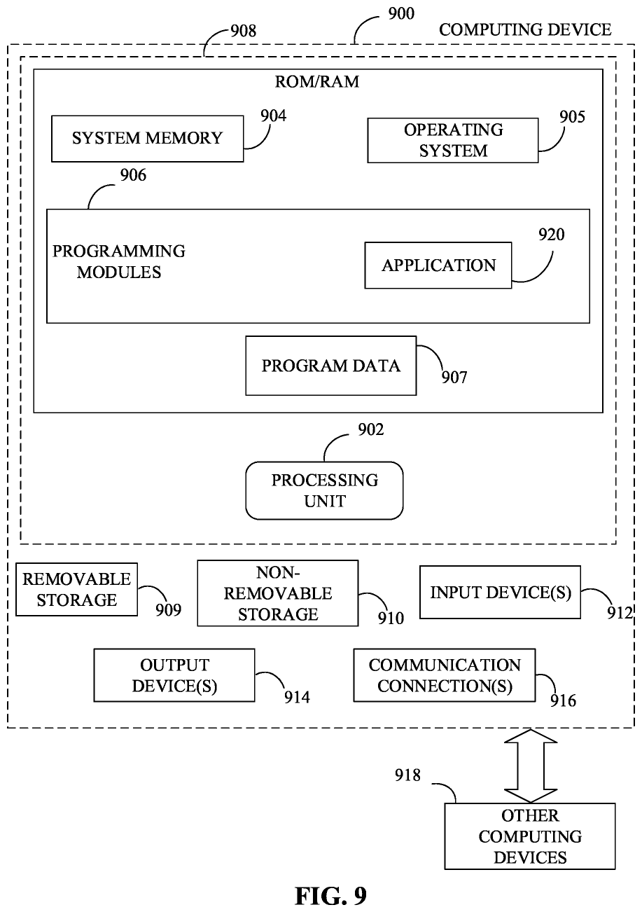

With reference to FIG. 9, a system consistent with an embodiment of the disclosure may include a computing device or cloud service, such as computing device 900. In a basic configuration, computing device 900 may include at least one processing unit 902 and a system memory 904. Depending on the configuration and type of computing device, system memory 904 may comprise, but is not limited to, volatile (e.g. random-access memory (RAM)), non-volatile (e.g. read-only memory (ROM)), flash memory, or any combination. System memory 904 may include operating system 905, one or more programming modules 906, and may include a program data 907. Operating system 905, for example, may be suitable for controlling computing device 900's operation. In one embodiment, programming modules 906 may include image-processing module, machine learning module. Furthermore, embodiments of the disclosure may be practiced in conjunction with a graphics library, other operating systems, or any other application program and is not limited to any particular application or system. This basic configuration is illustrated in FIG. 9 by those components within a dashed line 908.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 909 and a non-removable storage 910. Computer storage media may include volatile and non-volatile, removable and non-removable media implemented in any method or technology for storage of information, such as computer-readable instructions, data structures, program modules, or other data. System memory 904, removable storage 909, and non-removable storage 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 912 such as a keyboard, a mouse, a pen, a sound input device, a touch input device, a location sensor, a camera, a biometric sensor, etc. Output device(s) 914 such as a display, speakers, a printer, etc. may also be included. The aforementioned devices are examples and others may be used.

Computing device 900 may also contain a communication connection 916 that may allow device 900 to communicate with other computing devices 918, such as over a network in a distributed computing environment, for example, an intranet or the Internet, Communication connection 916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 904, including operating system 905. While executing on processing unit 902, programming modules 906 (e.g., application 920 such as a media player) may perform processes including, for example, one or more stages of methods, algorithms, systems, applications, servers, databases as described above. The aforementioned process is an example, and processing unit 902 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A system for facilitating monitoring of an environment, the system comprising:
at least one camera configured for capturing at least one image of the environment;
an artificial intelligence (AI) processing unit communicatively coupled with the at least one camera, wherein the AI processing unit is configured for:
analyzing the at least one image using at least one machine learning model, wherein the at least one machine learning model is trained in at least one of object detection and object recognition;
detecting at least one of an identity and a location of at least one object present in the environment based on the analyzing;
determining a situation occurring in the environment based on the analyzing and the detecting; and
generating an alert for the situation based on the determining;
a radio unit communicatively coupled with the AI processing unit, wherein the radio unit is configured for transmitting the alert to at least one device; and
at least one alternative energy capturing device electrically coupled with the at least one camera, the AI processing unit, and the radio unit, wherein the at least one alternative energy capturing device is configured for harvesting alternative energy from at least one alternative energy source, wherein the at least one alternative energy capturing device is configured for powering the at least one camera, the AI processing unit, and the radio unit based on the harvesting.

2. The system of claim 1, wherein the at least one alternative energy capturing device comprises a photovoltaic panel comprised of one or more photovoltaic cells, wherein the one or more photovoltaic cells is configured for harvesting solar energy from sunlight, wherein the powering of the at least one camera, the AI processing unit, and the radio unit is further based on the harvesting of the solar energy.

3. The system of claim 2, wherein the photovoltaic panel is configured to be mounted on the at least one camera using at least one mounting mechanism, wherein the at least one mounting mechanism is configured to allow for independent movement of the photovoltaic panel and the at least one camera, wherein the one or more photovoltaic cells receive the sunlight based on mounting of the photovoltaic panel, wherein the harvesting of the sunlight is based on receiving of the sunlight.

4. The system of claim 2, wherein the one or more photovoltaic cells is comprised in a camera body of the at least one camera forming the photovoltaic panel on the camera body, wherein the camera body is exposed to the sunlight, wherein the one or more photovoltaic cells receive the sunlight based on exposing of the photovoltaic panel, wherein the harvesting of the sunlight is based on receiving of the sunlight.

5. The system of claim 1, wherein the at least one camera comprises at least one of a visible light camera and an infrared light camera, wherein the visible light camera is configured for capturing at least one visible light image of the environment and the infrared light camera is configured for capturing at least one infrared light image of the environment, wherein the at least one image comprises at least one of the at least one visible light image and the at least one infrared light image.

6. The system of claim 1 further comprising a weatherproof enclosure configured for housing at least one of the at least one camera, the AI processing unit, and the radio unit, wherein the weatherproof enclosure is configured for shielding at least one of the at least one camera, the AI processing unit, and the radio unit from at least one weather condition of the environment based on the housing.

7. The system of claim 1, wherein the at least one camera is configured for capturing at least one subsequent image based on the determining of the situation, wherein the AI processing unit is further configured for:
analyzing the at least one subsequent image using at least one first machine learning model, wherein the at least one first machine learning model is trained in at least one of object detection and object recognition associated with the situation;
identifying at least one object of interest associated with the situation based on the analyzing of the at least one subsequent image; and
generating at least one command for the at least one camera based on the identifying of the at least one object of interest, wherein the at least one camera is further configured for configuring at least one camera parameter of the at least one camera for capturing at least one identifiable image of the at least one object of interest based on the at least one command, wherein the radio unit is further configured for transmitting the at least one identifiable image to the at least one device.

8. The system of claim 1, wherein the radio unit is further configured for transmitting the at least one image to the at least one device, wherein the at least one device is configured for presenting the at least one image to at least one user associated with the at least one device.

9. The system of claim 8, wherein the transmitting of the at least one image comprises broadcasting the at least one image to the at least one device using at least one wireless communication network, wherein the at least one device is configured to be connected to the at least one wireless communication network.

10. The system of claim 1 further comprising at least one passive sensor communicatively coupled with the at least one camera, wherein the at least one passive sensor is configured for generating at least one signal based on passively sensing a presence of the at least one object in the environment, wherein the at least one camera is configured to be activated for the capturing of the at least one image of the environment based on the at least one signal.

11. The system of claim 10, wherein the at least one passive sensor is further configured for generating at least one first signal based on passively sensing a movement of the at least one object in the environment based on the passively sensing of the presence of the at least one object, wherein the at least one camera is configured to be activated for the capturing of the at least one image of the environment based on the at least one first signal.

12. The system of claim 1, wherein the at least one device comprises at least one alarm device, wherein the at least one alarm device is configured for outputting an alarm signal based on the alert.

13. The system of claim 1 further comprising a memory unit communicatively coupled with the at least one camera, wherein the memory unit is configured for storing the at least one image.

14. The system of claim 13, wherein the memory unit is communicatively coupled with the AI processing unit, wherein the memory unit is further configured for retrieving at least one historical image of the environment, wherein the AI processing unit is further configured for:
analyzing the at least one historical image of the environment using at least one second machine learning model, wherein the at least one second machine learning model is trained in pattern detection of historical occurrences of the situations in the environment;
determining a part of a day with a likelihood of the occurring of the situation based on the analyzing of the at least one historical image; and
generating at least one first command based on the determining of the part of the day, wherein the at least one camera is configured to be activated for the part of the day for the capturing of the at least one image based on the at least one first command.

15. The system of claim 1, wherein the at least one alternative energy capturing device comprises a wind turbine, wherein the wind turbine is configured for harvesting wind energy from wind, wherein the powering of the at least one camera, the AI processing unit, and the radio unit is further based on the harvesting of the wind energy.

16. A system for facilitating monitoring of an environment, the system comprising:
at least one camera configured for capturing at least one image of the environment;
an artificial intelligence (AI) processing unit communicatively coupled with the at least one camera, wherein the AI processing unit is configured for:
analyzing the at least one image using at least one machine learning model, wherein the at least one machine learning model is trained in at least one of object detection and object recognition;
detecting at least one of an identity and a location of at least one object present in the environment based on the analyzing;
determining a situation occurring in the environment based on the analyzing and the detecting; and
generating an alert for the situation based on the determining;
a radio unit communicatively coupled with the AI processing unit, wherein the radio unit is configured for transmitting the alert to at least one device;
at least one alternative energy capturing device electrically coupled with the at least one camera, the AI processing unit, and the radio unit, wherein the at least one alternative energy capturing device is configured for harvesting alternative energy from at least one alternative energy source, wherein the at least one alternative energy capturing device is configured for powering the at least one camera, the AI processing unit, and the radio unit based on the harvesting; and
at least one passive sensor communicatively coupled with the at least one camera, wherein the at least one passive sensor is configured for generating at least one signal based on passively sensing a presence of the at least one object in the environment, wherein the at least one camera is configured to be activated for the capturing of the at least one image of the environment based on the at least one signal.

17. The system of claim 16, wherein the photovoltaic panel is configured to be mounted on the at least one camera using at least one mounting mechanism, wherein the at least one mounting mechanism is configured to allow for independent movement of the photovoltaic panel and the at least one camera, wherein the one or more photovoltaic cells receive the sunlight based on mounting of the photovoltaic panel, wherein the harvesting of the sunlight is based on receiving of the sunlight.

18. The system of claim 16, wherein the one or more photovoltaic cells is comprised in a camera body of the at least one camera forming the photovoltaic panel on the camera body, wherein the camera body is exposed to the sunlight, wherein the one or more photovoltaic cells receive the sunlight based on exposing of the photovoltaic panel, wherein the harvesting of the sunlight is based on receiving of the sunlight.

19. The system of claim 16, wherein the at least one camera comprises at least one of a visible light camera and an infrared light camera, wherein the visible light camera is configured for capturing at least one visible light image of the environment and the infrared light camera is configured for capturing at least one infrared light image of the environment, wherein the at least one image comprises at least one of the at least one visible light image and the at least one infrared light image.

20. The system of claim 16, wherein the at least one passive sensor is further configured for generating at least one first signal based on passively sensing a movement of the at least one object in the environment based on the passively sensing of the presence of the at least one object, wherein the at least one camera is configured to be activated for the capturing of the at least one image of the environment based on the at least one first signal.
